(19) United States
(12) Patent Application Publication
(10) Pub. No.: US 2013/0249156 A1
(43) Pub. Date: Sep. 26, 2013

(54) CLAMP APPARATUS

(71) Applicants: Yosuke Haruna, Kobe-shi (JP); Gaku Yoshimura, Kobe-shi (JP)

(72) Inventors: Yosuke Haruna, Kobe-shi (JP); Gaku Yoshimura, Kobe-shi (JP)

(73) Assignee: KOSMEK LTD., Hyogo (JP)

(21) Appl. No.: 13/990,535

(22) PCT Filed: Nov. 18, 2011
(86) PCT No.: PCT/JP2011/076680

§ 371 Date: May 30, 2013

(30) Foreign Application Priority Data
Dec. 2, 2010 (JP) 2010-285121

(51) Int. Cl. B23Q 3/06; B23Q 3/08

(52) U.S. Cl. CPC B23Q 3/06; B23Q 3/08
USPC 269/32; 269/48.1

(57) ABSTRACT

A clamp apparatus comprises a guide member with a top wall and a circumferential wall that protrude above a housing and are inserted into a hole of a work. The guide member is inserted into the housing to be movable downward against an advancing unit that pushes the guide member upward, within a locking stroke of downward movement. Through the circumferential wall, a plurality of guide grooves are made at predetermined intervals in circumferential directions. A locking member inserted into each guide groove is biased radially inward by an annular elastic member which is a thin strip. A clamp rod has wedge surfaces engaging with the respective locking members from above, and is clamp-driven downward and unclamp-driven upward by a piston.

### TECHNICAL FIELD

The present invention relates to a clamp apparatus which is arranged to cause a locking member to engage with a hole formed in an object to be fixed such as a work and a mold and to pull and fix the object via the locking member.

### BACKGROUND ART

An example of such a clamp apparatus is recited in Patent Literature 1(Japanese Patent No. 4297511). This conventional art is arranged as follows.

Four grip members are fitted externally to an upper part of a clamp rod with predetermined gaps being formed in circumferential directions, and the grip members are radially biased inward by an O-ring made of rubber and pushed upward by a hydraulic advancing unit. When the clamp is driven, to begin with, the grip members maintained at an elevated position by a predetermined force of the advancing unit are pushed radially outward by tapered surfaces of the clamp rod, so that the peripheries of the grip members engage with a hole of a work. Thereafter, the grip members engaging with the work are brought down by the clamp rod against the advancing unit. As a result, the clamp rod pulls the work downward via the grip members and fixes the work to the upper surface of the housing.

### CITATION LIST

### Patent Literature

Patent Literature 1: Japanese Patent No. 4297511

### SUMMARY OF INVENTION

### Technical Problem

The conventional art above involves the following problems.

When the clamp is driven, because the grip members are pushed radially outward, a wide gap is formed between neighboring grip members. If a foreign matter such as swarf or dust is caught in the gap, the grip members cannot move radially inward and are kept at radially outside positions. If one attempts to fit the hole of the work with the grip members in this state, the lower part of the circumferential wall of the hole collides the upper end of each grip member and the grip member is damaged.

Furthermore, according to the conventional art, parts where the tapered surfaces of the clamp rod engage with the tapered surfaces of the grip members are exposed upward. On this account, a foreign matter may be caught at the engaging parts and the tapered surfaces may be damaged.

For the reasons above, the above-described clamp apparatus of the conventional art breaks down often and is poor in maintainability.

An object of the present invention is to provide a clamp apparatus which is good in maintainability.

### Solution to Problem

To achieve the object above, the clamp apparatus is arranged as below as shown in FIG. 1A to FIG. 2B or FIG. 3 to FIG. 6.

A guide member 16 includes a top wall 17 and a circumferential wall 18 protruding to a leading end side as compared to a housing 1 and inserted into a hole 21 of an object 20 to be fixed. The guide member 16 is inserted into the housing 1 to be movable toward a base end side against an advancing unit 26 that pushes the guide member 16 toward the leading end side, within a locking stroke of moving the guide member 16 toward the base end side. A plurality of guide grooves 23 are formed on the circumferential wall 18 of the guide member 16 at predetermined intervals in a circumferential direction and radially penetrate the circumferential wall 18. A plurality of locking members 24 are inserted into the respective guide grooves 23 to be radially movable, are biased radially inward by an elastic member 50 or 52. Each of the locking members 24 includes a engaging portion 45 which is pressed onto an inner peripheral surface of the hole 21 of the object 20 to be fixed. A clamp rod 32 includes wedge surfaces 35 engaging with the respective locking members 24 from the leading end side, and the clamp rod 32 inserted into the guide member 16 is clamp-driven toward the base end side and unclamp-driven toward the leading end side by a driver D.

The present invention achieves the following functions and effects.

In the unclamped state, the guide member and the locking members are maintained at an elevated position by a predetermined force of the advancing unit. In the clamp driving, to begin with, the clamp rod pushes out the locking members, which has been maintained at the elevated position by the predetermined force, radially outward along the guide grooves formed on the circumferential wall of the guide member, and causes the engaging portion of each locking member to engage with the hole of the work. Subsequently, the clamp rod moves down the locking members engaging with the work and the guide member against the advancing unit. As a result, the clamp rod pulls the work downward via the locking members and the work is fixed to the upper surface of the housing.

Between the guide grooves formed on the circumferential wall of the guide member and the locking members, only a small gap allowing the locking members to be radially movable is required. For this reason, being different from the conventional art above, it is possible to prevent a foreign matter such as swarf and dust from being caught at the locking members, and the elastic member causes the locking members to smoothly return radially inward. The locking members are therefore smoothly attached and detached to and from the hole of the work, and hence the damage to the locking members is prevented.

Furthermore, because the parts where the wedge surfaces of the clamp rod engage with the locking members are housed in a space enclosed by the top wall and the circumferential wall of the guide member, it is possible to prevent a foreign matter from being caught at the engaging parts.

Because of the above, the clamp apparatus of the present invention prevents the occurrence of a failure and is good in maintainability.

The present invention is preferably arranged so that the top wall 17 and the circumferential wall 18 of the guide member 16 are seamlessly formed in an integrated manner, and the clamp rod 32 is arranged to be inserted into the guide member 16 from the base end side of the circumferential wall 18.

With this arrangement, the guide member is easily manufactured and attains high durability with a simple structure. Furthermore, because the clamp rod is easily attached and detached, and this contributes to the improvement in the maintainability.

In addition to the above, the following arrangements are preferably added to the present invention.

The circumferential wall 18 of the guide member 16 includes a guide portion 40 inserted into the hole 21 of the object 20 to be fixed and a guide base portion 41 which is formed to be larger in diameter than the guide portion 40 and inserted into the housing 1. A base end face 24a of each of the locking members 24 is supported to be radially movable by either the guide base portion 41 of the guide member 16 or an interlocked member 27 that axially moves together with the guide member 16.

In this case, because the base end face of the locking member is supported by the large-diameter guide base portion or the interlocked member, the inclination of the locking member at the time of the clamp driving is prevented and the locking member smoothly moves.

In addition to the above, the present invention is preferably arranged so that the guide grooves 23 are formed to be lined up on the guide portion 40 and the guide base portion 41 of the guide member 16, and each of the locking members 24 is constituted by the engaging portion 45 formed on the leading end side and a thick lock base portion 46 that is on the base end side as compared to the engaging portion 45 and protrudes radially outward as compared to the engaging portion 45.

According to this arrangement, the height of the locking member inserted into the guide groove can be increased. Furthermore, because the large-diameter lock base portion of the locking member is guided by the large-diameter guide base portion or the interlocked member, the prevention of the inclination of the locking members at the time of the clamp driving is ensured, and the locking members further smoothly move.

In addition to the above, preferably, in an unclamped state in which the clamp rod 32 is unclamp-driven, an outer peripheral surface of the engaging portion 45 of each of the locking members is provided radially inside as compared to an outer peripheral surface of the guide portion 40 of the circumferential wall 18.

According to this arrangement, when the guide member is inserted into the hole of the work at the time of bringing the work, the guide member prevents the circumferential wall of the hole from colliding the locking members. It is therefore possible to properly use the locking members for a long time.

Preferably, the elastic member 50 is formed to have an annular shape and attached to the outer peripheral surface of the guide base portion 41 and the outer peripheral surface of the lock base portion 46.

Furthermore, preferably, attaching grooves 48 and 49 are formed on the outer peripheral surface of the guide base portion 41 and the outer peripheral surface of the lock base portion 46, respectively, to circumferentially extend, and the elastic member 50 which is formed to be a thin strip is attached to the attaching grooves 48 and 49.

According to this arrangement, on the circumferential wall of the guide member, the attaching grooves are formed on the guide base portion which is formed to be thicker than the guide portion. The strength of the guide member is therefore improved as compared to a case where attaching grooves are formed on the guide portion.

The elastic member 52 may be provided in an annular space between the housing 1 and the guide base portion 41 to bias at least one of the guide member 16 and the locking members 24 radially inward.

Furthermore, preferably, the elastic member 52 provided between the housing 1 and the guide base portion 41 is constituted by dust seal, and an inner circumferential part of the dust seal contacts an outer peripheral surface of the elastic member 50 attached to an outer peripheral surface of the guide base portion 41 and an outer peripheral surface of the lock base portion 46.

This ensures the prevention of the intrusion of a foreign matter such as swarf and dust into the housing.

For example, as shown in FIG. 1A to FIG. 2B, further preferably, a receiving portion 54, 55 that prevents a base end portion of a radially inside surface of the lock base portion 46 from moving inward is provided on an outer circumference of the clamp rod 32.

With this, the prevention of the inclination of the locking members at the time of the clamp driving is ensured, and the locking members further smoothly move.

In addition to the above, to ensure the prevention of the inclination of the locking members 24 at the time of the clamp driving, as shown in FIG. 5, for example, a plurality of receiving surfaces 34 are formed to be axially lined up on a radially inside surface of each of the locking members 24, and wedge surfaces 35 engaging with the respective receiving surfaces 34 from the leading end side are formed on the clamp rod 32 to be axially lined up.

Furthermore, as shown in FIG. 1A, for example, a seated surface 58 for receiving the object 20 to be fixed is provided on the housing 1, and an ejection hole 59 for pressurized air is opened on the seated surface 58 to be used by a seating sensor, and a mounting surface 61, which supports the object 20 to be fixed at a position on the leading end side as compared to the seated surface 58 when the guide member 16 is advanced to the leading end side by the advancing unit 26, is provided on the guide member 16.

In addition to the above, the guide member 16 and the clamp rod 32 are provided to be movable radially with respect to the housing 1.

### BRIEF DESCRIPTION OF DRAWINGS

FIG. 1A relates to First embodiment of the present invention and is a cross section of a clamp apparatus in an unclamped state, when viewed in elevation.

FIG. 1B is a cross section taken at the 1B-1B line in FIG. 1A.

FIG. 1C is a cross section taken at the 1C-1C line in FIG. 1A.

FIG. 2A is a cross section of the clamp apparatus in a clamped state, when viewed in elevation.

FIG. 2B is a cross section taken at the 2B-2B line in FIG. 2A.

FIG. 3 relates to Second Embodiment of the present invention and is a partial view similar to FIG. 1A above.

FIG. 4 relates to Third Embodiment of the present invention and is a partial view similar to FIG. 1A above.

FIG. 5 relates to Fourth Embodiment of the present invention and is a partial view similar to FIG. 1A above.

FIG. 6 relates to Fifth Embodiment of the present invention and is a partial view similar to the clamped state shown in FIG. 2A above.

### REFERENCE SIGNS LIST

1: HOUSING, 16: GUIDE MEMBER, 17: TOP WALL, 18: PERIPHERAL WALL, 20: OBJECT TO BE FIXED (WORK), 21: HOLE, 23: GUIDE GROOVE, 24: LOCKING MEMBER, 24a: BASE END FACE, 26: ADVANCING UNIT, 27: INTERLOCKED MEMBER, 32: CLAMP ROD, 34: RECEIVING SURFACE, 35: WEDGE SURFACE, 40: GUIDE PORTION, 41: GUIDE BASE PORTION, 45: ENGAGING PORTION, 46: LOCK BASE PORTION, 48, 49: ATTACHING GROOVES, 50: ELASTIC MEMBER, 52: ELASTIC MEMBER (DUST SEAL), 54: RECEIVING PORTION (FIRST RECEIVING PORTION), 55: RECEIVING PORTION (SECOND RECEIVING PORTION), 58: SEATED SURFACE, 59: EJECTION HOLE, 61: MOUNTING SURFACE, D: DRIVER

### DESCRIPTION OF EMBODIMENTS

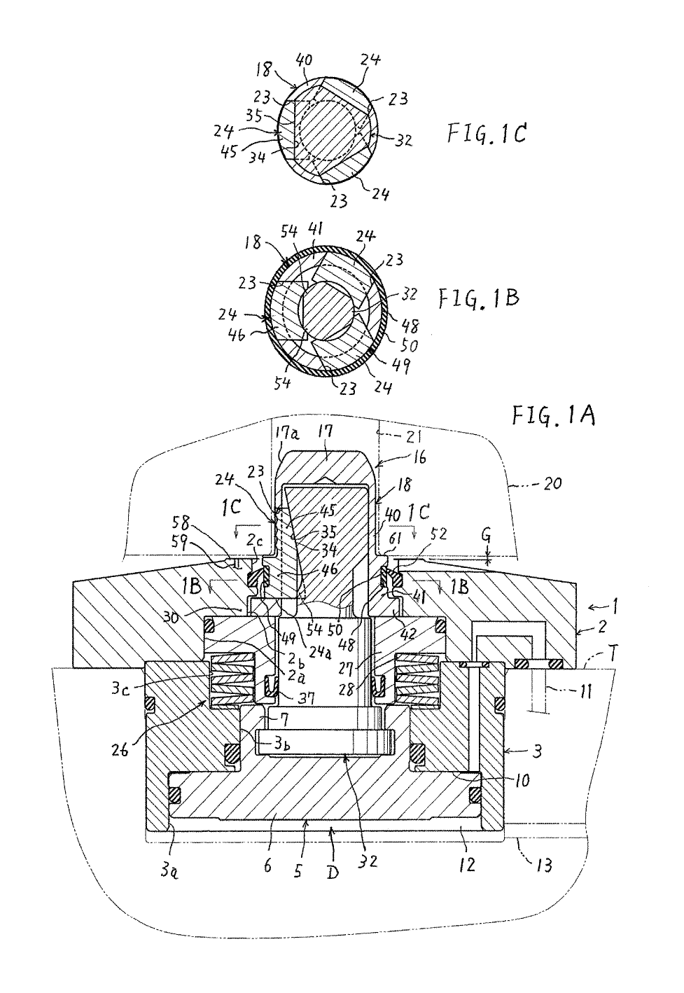

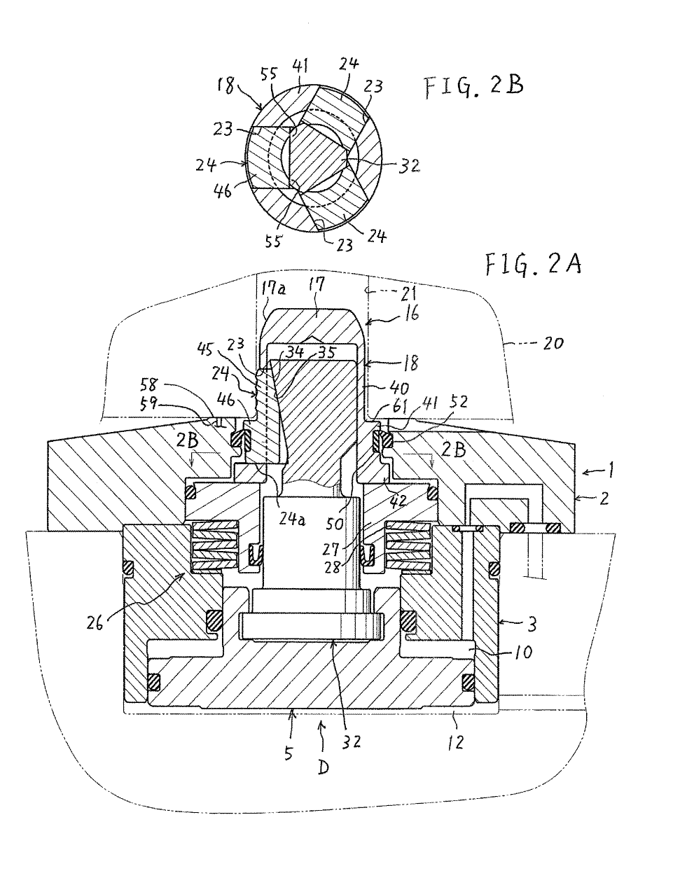

FIG. 1A to FIG. 2B relate to First embodiment of the present invention. A clamp apparatus of this First embodiment is used for fixing a work which is an object to be fixed. To begin with, the structure of the clamp apparatus will be described with reference to mainly FIG. 1A to FIG. 1C.

To a fixing board T such as a table, a housing 1 is attached. The housing 1 includes an upper housing 2 and a lower housing 3. The upper and lower housings 2 and 3 are fastened with each other by a plurality of bolts (not illustrated). In an upward direction, a large-diameter hole 2a, a middle-diameter hole 2b, and a small-diameter hole 2c are formed in the upper housing 2 in this order. Furthermore, in the upward direction, a large-diameter cylinder hole 3a, a small-diameter cylinder hole 3b, and a middle-diameter upper hole 3c are formed in the lower housing 3 in this order.

In the large-diameter cylinder hole 3a a piston main body 6 of a piston 5 is hermetically inserted, whereas in the small-diameter cylinder hole 3b a piston rod 7 is hermetically inserted. From and to a clamp chamber 10 formed above the piston main body 6, pressurized oil is supplied and discharged via a supply and discharge port 11. Furthermore, from and to an unclamp chamber 12 formed below the piston main body 6, pressurized oil is supplied and discharged via another supply and discharge port 13.

The piston 5, the clamp chamber 10, and the unclamp chamber 12 constitute a driver D of a later-described clamp rod 32.

Into the upper housing 2, a guide member 16 is inserted to be movable in a vertical direction (axial direction). The guide member 16 includes a top wall 17 having a guide surface 17a and a circumferential wall 18. The top wall 17 and the circumferential wall 18 are seamlessly formed in an integrated manner. These walls protrude upward (i.e., on the leading end side) as compared to the upper end (leading end) of the upper housing 2 and can be inserted into a hole 21 of a work 20.

On the circumferential wall 18, three guide grooves 23 are formed at predetermined intervals in circumferential directions. The guide grooves 23 radially penetrate the circumferential wall 18. Into each guide groove 23, a locking member 24 is inserted to be radially movable.

An advancing unit 26 is provided to push the guide member 16 upward with a predetermined force. This advancing unit 26 includes a cylindrical interlocked member 27 that is inserted into the large-diameter hole 2a of the upper housing 2 and is movable in the vertical direction together with the guide member 16 and a plurality of coned disc springs 28 that bias the interlocked member 27 upward. The upward movement of the interlocked member 27 is prevented by a stepped portion 30 formed between the large-diameter hole 2a and the middle-diameter hole 2b. The coned disc springs 28 are attached to the above-described upper hole 3c of the lower housing 3.

Into the guide member 16, the clamp rod 32 can be inserted from the lower side (base end side) of the circumferential wall 18. A lower part of this clamp rod 32 is connected to the piston rod 7 to be radially movable. At an upper part of the clamp rod 32, an wedge surface 35 is formed to engage from above with a receiving surface 34 formed on an inner side of each locking member 24. The receiving surface 34 and the wedge surface 35 are sloped downward toward the axis of the clamp rod 32. These surfaces are flat surfaces in the present case.

Furthermore, to an annular gap formed between the outer peripheral surface of the clamp rod 32 and the above-described interlocked member 27, a U-shaped packing 37 is attached. This packing 37 prevents a foreign matter such as cutting oil from entering the driver D and biases the clamp rod 32 radially inward.

Now, the guide member 16, the locking member 24, and the clamp rod 32, which have been briefly described above, will be detailed.

The circumferential wall 18 of the guide member 16 includes a guide portion 40 inserted into the hole 21 of the work 20 and a guide base portion 41 which is larger in diameter than the guide portion 40 and inserted into the upper housing 2. From a lower part of this guide base portion 41, a flange 42 protrudes radially outward, and this flange 42 is inserted into the middle-diameter hole 2b to be radially movable.

As a result, the guide member 16 and the clamp rod 32 are arranged to be radially movable with respect to the housing 1.

The above-described guide grooves 23 are formed on the guide portion 40 of the guide member 16 and the guide base portion 41 to be lined up in the vertical direction.

Furthermore, each of the locking members 24 inserted into the guide groove 23 is constituted by a engaging portion 45 pressed onto the inner peripheral surface of the hole 21 of the work 20 and a lock base portion 46 formed below the engaging portion 45. The lock base portion 46 is a thick portion and protrudes radially outward as compared to the engaging portion 45. The lower surface of the lock base portion 46, which surface is a lower end surface (base end surface) 24a of the locking member 24, is supported by the upper surface of the flange 42 of the guide base portion 41 to be radially movable.

On the outer peripheral surface of the guide base portion 41, attaching grooves 48 are formed to extend in circumferential directions. An attaching groove 49 is also formed on the outer peripheral surface of each lock base portion 46 to extend in circumferential directions. To these attaching grooves 48 and 49, an elastic member 50 which is a thin strip made of rubber or synthetic resin is attached. With this arrangement, the elastic member 50 biases the locking members 24 radially inward.

In addition to the above, in an annular space formed between the above-described small-diameter hole 2c of the upper housing 2 and the guide base portion 41, a dust seal (elastic member) 52 is provided to bias the guide member 16 radially inward. This dust seal 52 is made of synthetic resin or the like, and contacts, at its inner circumferential part, the outer peripheral surface of the elastic member 50. With this arrangement, the dust seal 52 biases the locking member 24 and the guide member 16 radially inward.

Furthermore, to prevent the lower end portion of the radially inside surface of the lock base portion 46 of the locking member 24 from moving radially inward, two receiving portions, i.e., first and second receiving portions 54 and 55 are provided on the outer circumference of the clamp rod 32. That is to say, in the initial stage of clamp driving of switching the unclamped state shown in FIG. 1A to the clamped state shown in FIG. 2A, as shown in FIG. 1A and FIG. 1B, the first receiving portion 54 contacts the lower end portion of the inside surface of the lock base portion 46. In the middle and late stages of the clamp driving, as shown in FIG. 2B, the second receiving portion 55 contacts the lower end portion of the inside surface of the lock base portion 46. These two receiving portions 54 and 55 are preferably formed to be adjacent in the vertical direction.

In addition to the above, the upper housing 2 is provided with a seated surface 58 for receiving the work 20, and an ejection hole 59 for ejecting pressurized air is opened on the seated surface 58 to be used by a seating sensor (not illustrated). Furthermore, a mounting surface 61 supporting the work 20 is provided on the upper surface of the guide base portion 41 of the guide member 16. The mounting surface 61 supports, as shown in FIG. 1A, the work 20 at a position above the seated surface 58 when the advancing unit 26 advances the guide member 16 upward.

The clamp apparatus above operates as described below.

In the unclamped state shown in FIG. 1A to FIG. 1C, the pressurized oil in the clamp chamber 10 is discharged and the pressurized oil is supplied to the unclamp chamber 12. With this, the piston 5 moves the clamp rod 32 upward to an unclamped position, the coned disc springs 28 move the guide member 16 and the locking member 24 upward to a released position via the interlocked member 27, and each locking member 24 is biased by the elastic member 50 radially inward. Because of the above, the outer peripheral surface of the engaging portion 45 of the locking member 24 is positioned inside as compared to the outer peripheral surface of the guide portion 40 of the circumferential wall 18 of the guide member 16. It is therefore possible to prevent, by the guide member 16, the circumferential wall of the hole 21 of the work 20 from colliding each locking member 24 when the work is brought as described below.

As the work 20 is moved down in the unclamped state, the hole 21 of the work 20 is externally fitted with the guide portion 40 of the circumferential wall 18 of the guide member 16 and the engaging portion 45 of the locking member 24, with a predetermined gap being formed therebetween, and the lower surface of the work 20 is received by the mounting surface 61 of the guide member 16.

At this stage, because a contact gap G is formed between the seated surface 58 of the upper housing 2 and the lower surface of the work 20, pressurized air is exhausted through the ejection hole 59, and hence the pressure in an air supply port (not illustrated) connected to the ejection hole 59 is lowered. When the pressure switch (seating sensor) detects this pressure drop, the state of the clamp apparatus is confirmed to be the unclamped state.

When the unclamped state shown in FIG. 1A is switched to the clamped state shown in FIG. 2A, the pressurized oil in the unclamp chamber 12 is discharged and the pressurized oil is supplied to the clamp chamber 10, so that the piston 5 is lowered.

In response to this, first of all, the clamp rod 32 is lowered with respect to the guide member 16 and the locking members 24 maintained at the elevated position by the urging force of the coned disc spring 28, the wedge surface 35 of the clamp rod 32 pushes the locking member 24 radially outward, and the engaging portion 45 of each locking member 24 engages with the hole 21 of the work 20 as the engaging portion 45 plastically deforms the inner peripheral surface of the hole 21 or frictionally contacts the inner peripheral surface. Subsequently, in this engaged state, the clamp rod 32 locking-drives the locking members 24 and the guide member 16 downward against the urging force of the coned disc springs 28. As a result, the locking member 24 pulls the work 20 downward and the lower surface of the work 20 is fixed to the seated surface 58 of the upper housing 2.

That is to say, the guide member 16 is, within its locking stroke, inserted into the upper housing 2 to be movable downward against the urging force of the coned disc springs 28 that push the guide member 16 upward.

In the initial stage of the locking stroke of the guide member 16 (i.e., in the initial stage of the clamp driving), as shown in FIG. 1A and FIG. 1B, the first receiving portion 54 prevents the lower end portion of the inside surface of the lock base portion 46 of each locking member 24 from moving radially inward. In the middle and late stages of the locking stroke (i.e., in the middle and late stages of the clamp driving), as shown in FIG. 2B, the second receiving portion 55 prevents the lower end portion of the inside surface of each lock base portion 46 from moving radially inward. This arrangement prevents each locking member 24 pushed radially outward by the wedge surface 35 of the clamp rod 32 from being inclined, and hence each locking member 24 smoothly moves radially outward.

In addition to the above, because the lower surface of the thick lock base portion 46 of the locking member 24 is supported on the upper surface of the large-diameter flange 42 of the guide base portion 41 of the guide member 16, each locking member 24 is moved smoothly and securely in a horizontal direction.

When the lower surface of the work 20 is fixed to the seated surface 58 of the upper housing 2 as described above, the ejection hole 59 is closed and hence the pressure in the air supply port (not illustrated) connected to the ejection hole is increased to a predetermined pressure. When this pressure increase is detected by a pressure switch (seating sensor), the state of the work 20 is confirmed to be the seated state.

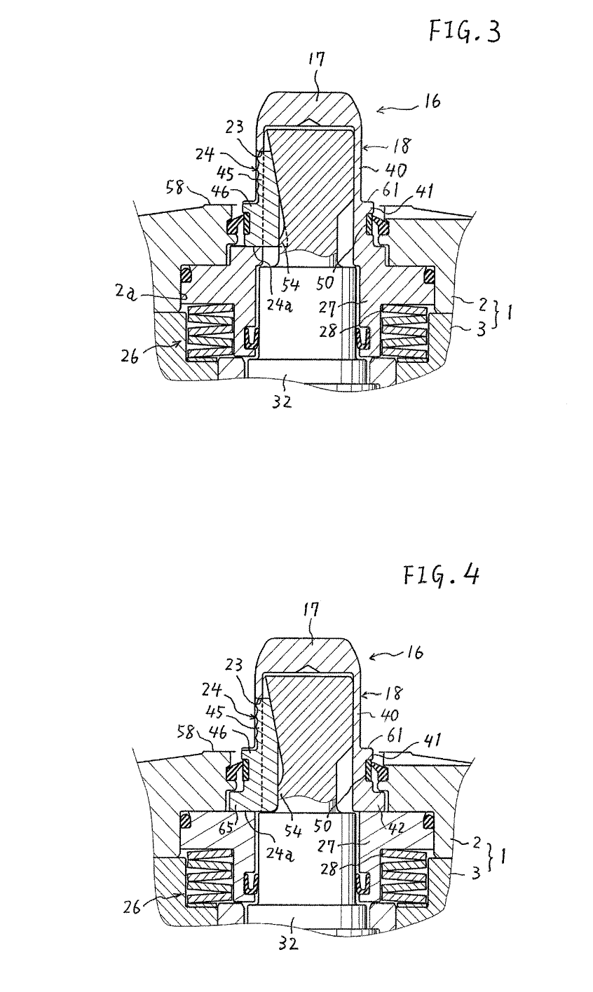

FIG. 3 to FIG. 6 show Second Embodiment to Fifth Embodiment of the present invention, respectively. In these embodiments, members identical with (or similar to) those of First embodiment will be basically denoted by the same reference numerals.

Second Embodiment show in FIG. 3 is arranged so that the guide member 16 is integrated with the interlocked member 27.

In this Second Embodiment, an annular gap may be formed between the outer peripheral surface of the interlocked member 27 and the large-diameter hole 2a of the upper housing 2. This allows the guide member 16 and the clamp rod 32 to radially move with respect to the housing 1.

In Third Embodiment shown in FIG. 4, the guide grooves 23 are opened on the lower surface of the circumferential wall 18 of the guide member 16. The locking members 24 are inserted into these guide grooves 23, and a flange 65 protrudes radially outward from a lower part of the lock base portion 46 of each locking member 24. And, on the upper surface of the interlocked member 27 that moves in a vertical direction together with the guide member 16, the lower surface of the flange 65 is supported to be radially movable. This ensures the prevention of the inclination of the locking members 24.

Fourth Embodiment shown in FIG. 5 is arranged so that a plurality of (two in this example) receiving surfaces 34 are lined up in the vertical direction on the radially inside surface of the locking member 24, and wedge surfaces 35 engaging with the respective receiving surfaces 34 from above are lined up in the vertical direction on the clamp rod 32.

With this structure, because the lower wedge surface 35 contacts the lower end portion of the radially inside surface of the locking member 24 in the whole locking stroke of the guide member 16, the prevention of the inclination of this locking member 24 is ensured.

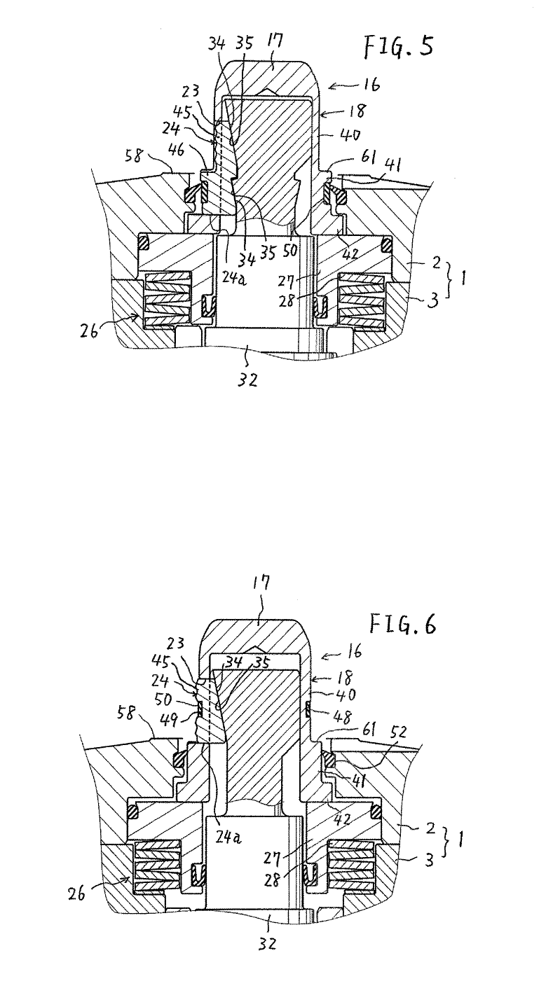

FIG. 6 relating to Fifth Embodiment shows a clamped state. In this Fifth Embodiment, the locking member 24 is provided only with the engaging portion 45. The lower end surface 24a of such a locking member 24 is supported by the upper end surface of the guide base portion 41 of the guide member 16. The attaching groove 49 is formed at a vertically central part of each locking member 24 and the attaching grooves 48 are formed at a vertically central part of the guide portion 40 of the guide member 16. The strip-shaped elastic member 50 is attached to these grooves 48 and 49.

When the state of the clamp apparatus is switched to the unclamped state (not illustrated), the outer circumference of the locking member 24 and the outer circumference of the elastic member 50 are positioned inside the outer circumference of the guide portion 40.

The embodiments may be modified as below.

The top wall 17 and the circumferential wall 18 of the guide member 16 may not be seamlessly formed in an integrated manner. The top wall 17 may be fastened to the circumferential wall 18 by a screw.

The advancing unit 26 may include an elastic member such as a compression coil spring and rubber instead of the coned disc springs 28 above. Furthermore, instead of such an elastic member, a structure utilizing pressurized oil (see e.g., Japanese Patent No. 4297511 which is the conventional art above) may be used. Furthermore, a structure utilizing compressed air or the like instead of pressurized oil may be used.

The elastic member 50 that biases the locking members 24 radially inward may be constituted by a flat spring made of belt metal, instead of rubber or synthetic resin.

Alternatively, the elastic member 50 is omitted and the locking member 24 is biased radially inward solely by the dust seal (elastic member) 52. Alternatively, the dust seal 52 solely has its primal function of preventing the intrusion of foreign matters, and the locking members 24 are biased radially inward solely by the elastic member 50.

While the number of the guide grooves 23 and the number of the locking members 24 are preferably 3 as in the example above, the number may be 2, 4, 5, or more.

Each guide groove 23 and each locking member 24 may be rectangular or oval in profile.

The outer peripheral surface of the engaging portion 45 of the locking member 24 may be flat or spherical in shape, instead of the serrated shape in the example above.

The wedge surface 35 of the clamp rod 32 may be an arc surface instead of the flat surface as in the example above.

Various modifications within the scope of the disclosure will be apparent to those skilled in the art.

1.-15. (canceled)

16. A clamp apparatus comprising:
a guide member including a top wall and a circumferential wall protruding to a leading end side as compared to a housing and configured to be inserted into a hole of an object to be fixed, the guide member configured to be inserted into the housing to be movable toward a base end side against an advancing unit that is configured to push the guide member toward the leading end side, within a locking stroke of moving the guide member toward the base end side;
a plurality of guide grooves formed on the circumferential wall of the guide member at predetermined intervals in a circumferential direction and configured to radially penetrate the circumferential wall;
a plurality of locking members inserted into the respective guide grooves to be radially movable, are biased radially inward by an elastic member, and each includes an engaging portion which is configured to be pressed onto an inner peripheral surface of the hole of the object to be fixed; and
a clamp rod including wedge surfaces engaging with the respective locking members from the leading end side, the clamp rod inserted into the guide member and configured to be clamp-driven toward the base end side and unclamp-driven toward the leading end side by a driver.

17. The clamp apparatus according to claim 16, wherein,
the top wall and the circumferential wall of the guide member are seamlessly formed in an integrated manner, and the clamp rod is configured to be inserted into the guide member from the base end side of the circumferential wall.

18. The clamp apparatus according to claim 16, wherein,
the circumferential wall of the guide member includes a guide portion configured to be inserted into the hole of the object to be fixed and a guide base portion which is formed to be larger in diameter than the guide portion and inserted into the housing, and
a base end face of each of the locking members is supported to be radially movable by either the guide base portion of the guide member or an interlocked member that axially moves together with the guide member.

19. The clamp apparatus according to claim 18, wherein,
the guide grooves are formed to be lined up on the guide portion and the guide base portion of the guide member, and
each of the locking members is constituted by the engaging portion formed on the leading end side and a thick lock base portion that is on the base end side as compared to the engaging portion and protrudes radially outward as compared to the engaging portion.

20. The clamp apparatus according to claim 18, wherein,
in an unclamped state in which the clamp rod is unclamp-driven, an outer peripheral surface of the engaging portion of each of the locking members is provided radially inside as compared to an outer peripheral surface of the guide portion of the circumferential wall.

21. The clamp apparatus according to claim 19, wherein,
the elastic member which is formed to have an annular shape is attached to an outer peripheral surface of the guide base portion and an outer peripheral surface of the lock base portion.

22. The clamp apparatus according to claim 21, wherein,
attaching grooves are formed on the outer peripheral surface of the guide base portion and the outer peripheral surface of the lock base portion, respectively, to circumferentially extend, and the elastic member which is formed to be a thin strip is attached to the attaching grooves.

23. The clamp apparatus according to claim 19, wherein,
in an annular space between the housing and the guide base portion, the elastic member is provided to bias at least one of the guide member and the locking members radially inward.

24. The clamp apparatus according to claim 23, wherein,
the elastic member provided between the housing and the guide base portion is constituted by a dust seal, and an inner circumferential part of the dust seal contacts an outer peripheral surface of the elastic member attached to an outer peripheral surface of the guide base portion and an outer peripheral surface of the lock base portion.

25. The clamp apparatus according to claim 19 wherein,
a receiving portion that prevents a base end portion of a radially inside surface of the lock base portion from moving inward is provided on an outer circumference of the clamp rod.

26. The clamp apparatus according to claim 19 wherein,
a plurality of receiving surfaces are formed to be axially lined up on a radially inside surface of each of the locking members, and wedge surfaces engaging with the respective receiving surfaces from the leading end side are formed on the clamp rod to be axially lined up.

27. The clamp apparatus according to claim 16 wherein,
the elastic member which is formed to have an annular shape is attached to an outer peripheral surface of the guide member and outer peripheral surfaces of the locking members.

28. The clamp apparatus according to claim 27, wherein,
attaching grooves are formed on the outer peripheral surface of the guide member and the outer peripheral surfaces of the locking members, respectively, to circumferentially extend, and the elastic member which is formed to be a thin strip is attached to the attaching grooves.

29. The clamp apparatus according to claim 16 wherein,
a seated surface for receiving the object to be fixed is provided on the housing, and an ejection hole for pressurized air is opened on the seated surface to be used by a seating sensor, and
a mounting surface, which is configured to support the object to be fixed at a position on the leading end side as compared to the seated surface when the guide member is advanced to the leading end side by the advancing unit, is provided on the guide member.

30. The clamp apparatus according to claim 16 wherein,
the guide member and the clamp rod are provided to be movable radially with respect to the housing.
